(19) United States
(12) Patent Application Publication
(10) Pub. No.: US 2024/0256701 A1
(43) Pub. Date: Aug. 1, 2024

(54) PROGRAMMATIC DATA SECURITY AND COMPLIANCE REMEDIATION FOR NETWORK COMPUTING ENVIRONMENT

(71) Applicant: Uber Technologies, Inc., San Francisco, CA (US)

(72) Inventors: Oliver Szimmetat, San Francisco, CA (US); Nabanita De, San Francisco, CA (US); Kaibo Ma, San Francisco, CA (US)

(21) Appl. No.: 18/421,854

(22) Filed: Jan. 24, 2024

Related U.S. Application Data
(60) Provisional application No. 63/441,726, filed on Jan. 27, 2023.

(51) Int. Cl. G06F 21/62; G06F 21/64

(52) U.S. Cl. CPC G06F 21/6245; G06F 21/64

(57) ABSTRACT

The network system implements a security and compliance service to ensure that a context classification of a data storage container is appropriate for individual data objects contained within it. If the data storage container is inappropriate for the data object, the network system performs remedial actions to avoid risk or harm from misclassification or potential exposure of the data object.

### RELATED APPLICATIONS

This application claims benefit of priority to Provisional U.S. Application No. 63/441,726, filed Jan. 27, 2023; the aforementioned priority application being hereby incorporated by reference in its entirety.

### TECHNICAL FIELD

Examples pertain to network computing environments, and more specifically, to programmatic data security and compliance remediation for a network computing environment.

### BACKGROUND

In a network computing environment, data storage containers can hold large amounts of data with various types of data objects (e.g., text files, documents, source code files, etc.). Data objects often contain data elements (e.g., alphanumeric characters and terms, source code, etc.) that are subject to security or compliance rules. For example, data that constitutes personal identifiable information (“PII”) can be subject to rules set by legal requirements, while financial data and credentials can be subject to organizational compliance rules (e.g., best practice) for safeguarding proprietary information. Data objects that are subject to legal requirements (e.g., because they contain PII) typically require enhanced security requirements. For example, such data objects may be encrypted, and data containers that contain such data objects may be inaccessible to the public. By contrast, data objects that contain financial information may be subject to a lesser requirement. As an example, a requirement for such data objects may be that the respective data container for such data objects be stored behind specific firewalls, so as to be logically isolated. Still further, other types of data objects may include non-sensitive or public information that can be stored in data containers that require a minimal amount of safeguards.

It is typical for data storage containers to be associated with a context classification (e.g., classification and/or label) that matches a security or compliance concern of data that is to be stored with the data container. For example, a Level 1 container may designate data storage containers that store highly sensitive information, such as PII of users. A Level 2 container can store business data that is confidential, but not PII of users. A Level 3 container can store non-sensitive information, which can include information that can be made public without concern. To properly comply with security or compliance rules, data objects should be stored in data storage containers that have a same or compatible security/compliance concern. For example, PII information of users should be stored in Level 1 data storage containers, while business information should be stored in Level 2 data storage containers. If sensitive data is stored in Level 3 data storage containers, for example, then the data may be inadvertently exposed to the public.

In managing a data collection of a network environment, care must be taken to store data objects in a proper data storage container, where the classification context of the data storage container matches the security/compliance concern of the data object. To illustrate, if data objects are over-classified as highly sensitive, the enterprise managing the network environment incurs unnecessary expense as a result of additional resources required to protect and/or enable access to data objects that are not highly sensitive. At the same time, if highly sensitive data objects are not maintained in, for example, a Level 1 data storage container with additional security measures (e.g., encryption), the manager/proprietor of the data collection may risk data breach and exposure of highly sensitive data.

Because of the sheer size and volume of data storage containers, it can be prohibitively expensive (e.g., from a time, resource, and/or cost perspective) or practically infeasible to check every data object in, for example, Level 2 or 3 containers to ensure that such data storage containers include no highly-sensitive information that should otherwise be stored in Level 1 containers.

### BRIEF DESCRIPTION OF FIGURES

FIG. 1 illustrates a network system for implementing a security and compliance service, according to one or more examples.

FIG. 2A illustrates a method for implementing a security and compliance service, according to one or more embodiments.

FIG. 2B illustrates a method for performing a security and compliance check on a data storage container that includes a context classification for retaining highly sensitive data, according to one or more embodiments.

FIG. 2C illustrates a method for performing a security and compliance check on a data storage container that includes a context classification for intermediate and/or non-sensitive data, according to one or more embodiments.

FIG. 3 is a block diagram that illustrates a network computer system upon which one or more embodiments described herein can be implemented.

### DETAILED DESCRIPTION

According to embodiments, a network system implements a security and compliance service to ensure that a context classification of a data storage container is appropriate for individual data objects contained within it. If the data storage container is inappropriate for the data object, the network system performs remedial actions to avoid risk or harm from misclassification or potential exposure of the data object.

In some embodiments, a network system determines a context classification for a data storage container, where the data storage container is provided with a memory resource of a network computing environment. Based on the context classification, one or more data objects that are stored in the data storage container are analyzed to determine whether each of the one or more data objects satisfies a set of rules associated with the context classification of the data storage container. In response to a determination that at least one of the one or more data objects does not satisfy the set of rules associated with the context classification, the network system performs one or more remediation actions.

Among other advantages, a network system as described with examples can implement security and compliance service to safeguard the data of an enterprise. The network system enables efficient use of resources to enforce security and compliance policies for a vast amount of data, with varying levels of security or compliance concerns. In network environments where data storage containers include thousands, if not millions (or more) of data objects, processes as described with embodiments allow for effective implementation of security and compliance policies to safeguard the storage and use of the network environment's data.

As used herein, a client device, a computing device, and/or a mobile computing device refer to devices corresponding to desktop computers, cellular devices or smartphones, laptop computers, tablet devices, etc., that can provide network connectivity and processing resources for communicating with a service arrangement system over one or more networks. In another example, a computing device can correspond to an in-vehicle computing device, such as an on-board computer. Also, as described herein, a user can correspond to a requester of a network service (e.g., a rider) or a service provider (e.g., a driver of a vehicle) that provides location-based services for requesters.

Still further, examples described relate to a variety of location-based (and/or on-demand) services, such as a transport service, a food truck service, a delivery service, an entertainment service, etc., to be arranged between requesters and service providers. In other examples, the system can be implemented by any entity that provides goods or services for purchase through the use of computing devices and network(s). For the purpose of simplicity, in examples described, the service arrangement system can correspond to a transport arrangement system that arranges transport and/or delivery services to be provided for riders by drivers of vehicles who operate service applications on respective computing devices.

One or more examples described provide that methods, techniques, and actions performed by a computing device are performed programmatically, or as a computer-implemented method. Programmatically, as used, means through the use of code or computer-executable instructions. These instructions can be stored in one or more memory resources of the computing device. A programmatically performed step may or may not be automatic.

One or more examples described can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

Some examples described can generally require the use of computing devices, including processing and memory resources. For example, one or more examples described may be implemented, in whole or in part, on computing devices such as servers, desktop computers, cellular or smartphones, and tablet devices. Memory, processing, and network resources may all be used in connection with the establishment, use, or performance of any example described herein (including with the performance of any method or with the implementation of any system).

Furthermore, one or more examples described may be implemented through the use of instructions that are executable by one or more processors. These instructions may be carried on a computer-readable medium. Machines shown or described with figures below provide examples of processing resources and computer-readable mediums on which instructions for implementing examples described can be carried and/or executed. In particular, the numerous machines shown with examples described include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

### System Description

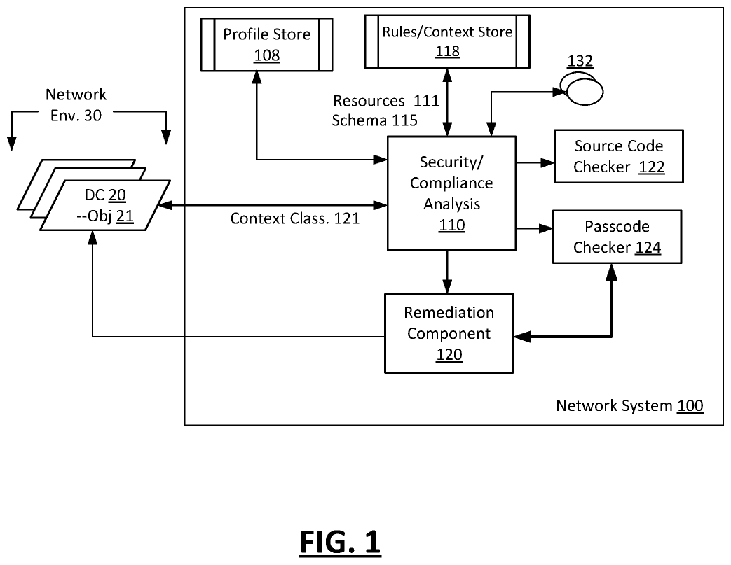

FIG. 1 illustrates a network system for implementing a security and compliance service, according to one or more examples. In examples, a network system 100 can implement a security and compliance service to selectively monitor and scan data storage containers of a network computing environment. In examples, the network system 100 implements the security and compliance service for data storage containers of an organization or account holder, as provided in a data center or similar network computing environment. The network system 100 implements the security and compliance service to ensure that a context classification of a data storage container is appropriate for individual data objects contained within it.

In examples, a network environment 30 includes a collection of data storage objects 20, where each data storage containers 20 includes one or more data objects 21. Further, each data object 21 can include data elements (e.g., content items, such as alphanumeric terms, source code, passwords and credentials, etc.). Each data storage container 20 can be associated with one of multiple context classifications 121, where each context classification is associated with a set of criteria and/or security/compliance rules. For example, each data storage container 20 can be associated with a context classification 121 at the time the data storage container 20 is created, either manually or by a programmatic entity that creates the data storage container.

The context classification 121 of the data storage container 20 can be tiered, where each tier defines a minimum level of safeguards or considerations that are deemed appropriate for data objects 21 that are stored with the data storage container 20. In some examples, the context classification of data storage containers 20 can be defined to correspond to one of (i) Level 1 classification, where the data storage container 20 is to be provided with a highest level of security requirements, such as encryption requirement for data objects 21 that are stored in the data storage container 20, and accessibility restrictions to the data storage container 20 (e.g., password protected storage container, data storage container being positioned behind firewalls so as to be accessible to limited users or entities, etc.); (ii) a Level 2 classification, with lesser security restrictions, such as placing accessibility restrictions to the storage container, without requirements for data storage objects 21 to be provided with added security features (e.g., no encryption); and (iii) a Level 3 classification, which may include standard security and compliance features, such as protection of the storage container from public access. Generally, the context classification of data storage containers should be match, or otherwise be appropriate for the security and compliance concern of the data stored by the respective data storage containers. Given the volume of data objects and data storage containers, as well as the processes that generate and use the data, occasions arise where data objects are misplaced. This can occur when, for example, data elements provided by data objects have a greater level of security/compliance concern than what is appropriate for the context classification of the respective data storage container.

Each data object which is stored in a storage container 20 of the network environment 30 can be associated with a security concern, based on the nature and characteristics of the data elements (e.g., content elements) contained with the data object 21. Initially, the security/compliance concern of data objects 21 may 21 may be assumed to match the context classification 121 of the respective data storage container (e.g., Level 1, Level 2, Level 3). The network system 100 can scan containers and the data objects 21 therein, and further analyze the data objects 21 for individual data storage containers to confirm that the data object is appropriate for the data storage container. However, in some cases, the network system 100 determines the data object is mismatched to (or not appropriate for) its data storage container, because, for example, the data object includes one or more data elements that require a higher level of security/concern than what is provided for by the context classification of the data storage container. In this way, the presumed security/compliance concern of individual data objects can change, based on the analysis performed by the network system 100.

For example, each data object 21 can include a file or folder with additional files, where individual files are of various data types (e.g., JSON, CPP, CXX, CC, HPP, TEXT, PDF, JPEG, PNG, DOC, MPEG, MP4, etc.). Data elements may be provided by data objects 21 in the form of content contained or associated with the files. As described in greater detail, data objects can be associated with a data concern, based on data elements contained or provided by the data object 21. Further, the data concern that is associated with a data object can be pre-defined, to match the tiered context classification that is implemented for the data storage containers. Accordingly, the security/compliance concern of data objects 21 can include, for example, (i) a Level 1 classification, for data objects that are deemed to be highly sensitive (e.g., personal identifiable information (“PII”) of persons, passcodes (e.g., access codes, passwords and other credentials) or other secret data that are deemed to have the highest security/compliance concern; (ii) a Level 2 classification for business data (e.g., financial information, internal enterprise documents) and other confidential or secret data which are deemed to have lesser risk to an enterprise if breached or exposed; and (iii) a Level 3 classification for public or non-sensitive data objects. While examples as described provide for three context classifications as described, in variations, the network system 100 can be implemented where the two, four or more context classifications 121, where the context classifications 121 are pre-defined for data object containers 20.

The determinations made by the network system 100 can include a determination as to whether the data objects 21 of a data storage container are appropriate. In some examples, the data objects stored 21 with a data storage container are appropriate if a security/compliance concern of the data object matches the context classification of the data storage container 20. Additionally, in variations, data objects with lesser sensitivity concerns (e.g., Level 3 concern) can be stored in data storage containers 20 having context classifications 121 that are of greater concern (e.g., Level 2 concern).

In examples, the network system 100 includes a security compliance analysis component (“SCA component 110”) and a remediation component 120. The SCA component 110 scans data storage containers 20 to identify and analyze individual data objects 21, in order to determine whether inclusion of the data object 21 with the data storage container 20 is appropriate. In examples, if the SCA component 110 determines that the context classification 121 of the data storage container 20 is of a lesser sensitivity than that which is required for the data object 21, then the determination of the SCA component 110 can be that the data storage container 20 is not appropriate for the data object 21. As an example, if the data storage container has a Level 2 or Level 3 classification, and the SCA component 110 determines that the data object 21 being analyzed has a Level security/compliance concern, then the determination of the SCA component 110 is that the data storage container 20 is not appropriate for the data object 21. If a determination is made that a data object is not appropriate for its data storage container, then the remediation component 120 can implement one or more remediation actions to mitigate or eliminate the risk or exposure caused by the presence of the data object 21.

### Security/Compliance Analysis

The SCA component 110 can access and determine the context classification 121 of individual data storage containers 20. The SCA component 110 can identify the metadata of the data storage containers 20 and/or individual data objects 21 of the data storage container, in order to determine profile information 108 the respective data storage container 20 and/or data objects 21. The determined metadata can identify profile information from an account profile store 108. The profile information can directly or indirectly identify, for example, an organization or account identifier, a country or locality relevant to the data storage container 20, a type of activity or data that is used by the organization or account holder, and/or other aspects that may be indicative of the security requirements of the data objects 21 contained within the data storage container 20.

In examples, the SCA component 110 can also identify which data objects 21 of the data object container 20 are to be analyzed. For example, data objects 21 can be identified by attributes such as type or extension. Additionally, data objects 21 can be associated with other attributes (e.g., file size, creation date, modification data, etc.). Based on attribute(s), the SCA component 110 can select data objects 21 to analyze. For example, the SCA component 110 can select data objects 21 to analyze based on file type, size, creation date, or combination thereof. Further, the context classification 121 of the data storage container 20 can also factor in which data objects 21 are analyzed, or the sequence in which data objects are analyzed.

Further, the SCA component 110 can implement different processes for scanning, inspecting and/or analyzing data containers and objects, based on a variety of factors. For example, the SCA component 110 can scan text files (e.g., TXT, .DOC. etc.) for terms or markers that indicate or correspond to PII information (or markers thereof), passwords and secrets; while code files (e.g., JSON, CPP, CXX, CC, HPP, etc.) are scanned for passwords and secrets, but not PII information or markers. In such an embodiment, the SCA component 110 can be configured to ignore PII, or markers for terms that would otherwise be considered PII information because the term may be a variable or other integrated aspect of the coding. As an addition or variation, the SCA component 110 can apply a level of knowledge to the code terms, statements or structure, such that, for example, the SCA component 110 scans for PII in the comments of a code file, but not in the body of the code file. By configuring and implementing the processes performed by the SCA component 110 based on, for example, the type of data object 21 provided in a container, the amount of computing resources (e.g., processing, network traffic, etc.) that are used to adequately scan a container can be reduced.

The SCA component 110 can select a set of security/compliance resources 111 from a rules/context data store 118. The selection of the security/compliance resources 111 can be based on, for example, the network environment 30, the account holder of the data storage container 20, and/or the context classification 121 of the storage container 20. As an addition or an alternative, the SCA component 110 can also use additional profile information associated with the data storage container 20 to identify security/compliance resources 111 of the data storage container 20. For example, the profile information can associate the data storage container 20 with a geographic location (e.g., country, state, city, county, etc.), where, for example, the data is used or collected. As an addition or alternative, the profile information can associate the data storage container 20 with a specific type of data element that is sensitive and known to be used by the account (and thus more likely to be exposed by error). To illustrate the latter case, the profile information can associate the data storage container 20 with a particular type of business data (e.g., phone number), reflecting a business operation or service which uses the data storage container.

The security/compliance resources 111 can include a rule set that defines permissive inclusion criteria (e.g., criteria for defining data objects that can be included in the data storage container 20) and/or exclusion criteria (e.g., criteria for defining data objects that are to be excluded from the data storage container 20). For example, the security/compliance resources 111 can specify a rule set where the data objects 21 of data storage containers 20 having a high sensitivity concern (e.g., Level 1) are required to be encrypted. The security/compliance resources 111 may include a rule set that requires every data object 21 contained within a Level 1 data storage containers 20 is encrypted. As an addition or variation, the security/compliance resources 111 may include a rule set that excludes any data object 21 which is not encrypted from being contained in a Level 1 data storage container.

As an addition or variation, the security/compliance resources 111 can include a schema 115 that identifies a structure, format and/or marker for specific types of data elements contained by data objects 21. For example, the schema 115 can identify an alphanumeric pattern (e.g., ‘(xxx)’ where ‘xxx’ are digits), an arrangement of characters or data elements (e.g., a format of a driver's license), or other pre-defined attributes of content which is characteristic of a particular type of data element (e.g., phone number, driver's license, etc.). As another example, the schema 115 can identify formatting, such as formatting used for source code, which can have particular font or coloring variations between lines of code. As still another addition or variation, the schema 115 can identify markers that are indicative of a particular type of data element. By way of example, a marker can include ‘@’ and ‘.com’, with spacing constraints (e.g., appearing as same term) which can be indicative of an email address. As another example, a marker can include ‘*’ which can be indicative of source code, where the special character is designated for comments.

Other examples of markers can include alphanumeric combinations with are indicative of a particular type of data element. For example, an alphanumeric character set at the beginning of a larger character set can be a marker for a driver's license number in a given geographic region. As illustrated by such examples, the schema 115 can be specific to profile information associated with an account of the data storage container, such as the geographic region or location.

Still further, in some examples, the schema 115 can identify a list of passcodes (e.g., access keys, passwords or other credentials) and other types of secret data which are presumed to be associated with a particular level of security concern (e.g., Level 1). When the SCA component 110 scans a data object 21 of data storage container with a lesser context classification 121 (e.g., Level 2 or Level 3), the SCA component 110 can compare individual data elements of the data object with entries of a passcode/secret data list. If a match is found, the SCA component 110 can initiate a remediation action.

As described with some examples, the schema 115 can be geographic or location-specific (e.g., driver's license structure, format is for specific state or country). The schema 115, or aspects of the schema 115, can be selected based on the geographic location associated with the data storage container 20. For example, the markers and/or template for a driver's license number can vary based on the geographic location associated with the respective data storage container 20. Still further, the security/compliance concern associated with different types of data elements can vary based on location or geographic data associated with the data storage container 20, where the location or geographic data can be determined from metadata and/or the profile store 108.

Additionally, the schema 115 can be associated with rules and logic to specify or otherwise enable additional operations by the SCA component 110 with regards to determination of the security concern associated with a data object. In examples, the SCA component 110 scans a data object 21 for passcodes (e.g., access keys, passwords and other credentials) and other types of secret data. Such types of data elements can be identified based on, for example, a format or structure of the data element. Alternatively, such data elements can be identified using a predetermined list of known credentials. As an addition or alternative, in some examples, the SCA component 110 can scan for passcodes by first searching for data elements that are likely to contain passcodes. The SCA component 110 can use the schema 115 to identify whether individual data objects 21 include source code. The data type can be an indicator of whether the data object 21 contains source code (e.g., JSON, CPP, CXX, CC, HPP). As an addition or variation, the SCA component 110 can scan the content of the data object 21 for indicators of source code (e.g., by looking for particular types of formatting for text content, use of characters such as ‘*’ that are markers of comments, etc.). If the data object 21 is deemed to contain source code, the SCA component 110 can scan the source code content (or portions thereof) for terms that match the structure, format and/or characteristics of an access key or other passcode. Further, the SCA component 110 can use a source code checker 122 to identify whether malware or security vulnerabilities exist with the source code. If such vulnerabilities are deemed to exist, the SCA component 110 can identify the presence of such code as a security/compliance concern.

If such types of data elements are identified, the SCA component 110 makes one or more additional determinations to determine whether the identified data elements are active (e.g., in use). The SCA component 110 can access profile information of the account holder to determine one or more sources (e.g., code repository) where credentials of different types may be used. As an addition or variation, the SCA component 110 can identify the one or more sources for identified passcodes from the schema 115 and/or the profile store 108. Once identified, the SCA component 110 can initiate a programmatic process or workflow, represented by passcode checker 124, where the identified passcode(s) are checked. For example, the passcode checker 124 automatically and programmatically enter passcode and/or other credential information at the site of one or more protected sources (e.g., code repositories used by account holder). The passcode checker 124 can use logic that identifies, for example, the layout of the site. Each passcode can be programmatically submitted to a login/credential page of the source. Further, the SCA component 110 can access or use logic (such as may be provided by the credentials) to attempt access of the source. For example, after each passcode submission, the passcode checker 124 can evaluate the response (e.g., returned page denying access, interstitial page granting access, etc.), and based on the response, the SCA component 110 determines whether the passcode is active or inactive. If use of the passcode with the identified source results in access being provided to a protected source (e.g., code repository), then the SCA component 110 can initiate one or mor remediation actions.

In some examples, data objects 21 containing passcodes, whether active or inactive, are associated with the highest security concern. In such cases, the remediation action that is taken may vary based on whether the identified passcode(s) of the data object or active or inactive. In variations, data objects containing passcodes are associated with a highest security concern if any identified passcode(s) is determined to be active.

The security/compliance resources 111 can also include rules that indicate when, for example, a combination of data elements raise a heightened security compliance. The SCA component 110 can utilize the schema 115 to identify multiple types of data elements within a data object 21. If each of the multiple types of data element types are determined to be present within the data object 21, then the SCA component 110 can determine, based on the schema 115, that a particular security or compliance concern is raised by the data object 21. For example, the schema 115 can define data elements of concern to include location data for a user (e.g., time-stamped geographic coordinates of a user) and data that is unique to the user (e.g., a driver license picture, employee identifier, driver's license number, etc.). If the SCA component 110 determines that a data object includes one of the two data elements (e.g., time-stamped geographic coordinates for a user without other pre-defined data that is unique to the same user, or vice-versa), based on implementation, the SCA component 110 can determine that no additional security concern is raised. If, on the other hand, the SCA component 110 determines that both data elements are present with the data object, then the combination of the two data elements being present can raise the security concern associated with the data object 21 (e.g., from Level 2 to Level 3). In such case, the SCA component 110 can determine that the security or compliance concern raised by the data object 21 is not appropriate for the context classification 121 of the data storage container 20, and remedial action may be initiated.

Accordingly, as illustrated by examples, the SCA component 110 can analyze individual data objects 21 to determine whether the data objects 21 of a data storage container 20 are appropriate, given security/compliance concerns associated with the data object 21 and the context classification 121 of the data storage container 20. For example, the inclusion of the data object 21 with the data storage container 20 can be appropriate if the data object 21 satisfies, for example, a rule set that defines the permissive criteria for the data storage container 20. On the other hand, if the data object 21 fails to satisfy the permissive criteria, or if the data object 21 meets the exclusion criteria, the SCA component 110 can determine that remediation is required for the data object.

### Optimizations

In examples, the SCA component 110 can selectively implement scanning processes on data storge containers 20 to inspect data objects 21 of the respective data storage containers 20. Rather than analyze each data object 21 of a data storage container 20, the SCA component 110 can select which data objects 21 (or data storage containers 20) to inspect and analyze. The SCA component 110 can implement one or more rules or strategies to determine which data objects 21 or data storage containers 20 to inspect. For example, the SCA component 110 can select which data objects 21 of a data storage container 20 to inspect based on a tag or other attribute associated with the data object 21. For example, for a given data storage container 20, the SCA component 110 can inspect those data objects 21 that are associated with a tag that marks the data object 21 as “non-sensitive data”) and/or attribute (e.g., non-encrypted data object) that indicates the data object 21 contains non-sensitive data. The SCA component 110 an inspect such data objects to ensure that the data object 21 is appropriately classified, or stored in an appropriate data storage container 20.

Still further, in some examples, the SCA component 110 can be configured to scan data storage containers 20 at a particular time by inspecting a sample set of data objects 21 at the particular time, rather than inspecting all of the data objects 21. For example, the SCA component 110 can inspect a collection of data storage containers by inspecting a sample set of data objects from each data storage container. During a subsequent time interval, a different sample set of data objects 21 can be selected for analysis. In this way, SCA component 110 can repeatedly or continuously perform the scanning process at periodic intervals, such that at each interval, a different sample set of data objects is analyzed. Among other advantages, such a process can conserve computing resources as compared to a process where a data storage container 20 is subject to a full scan at each time interval. Further, by sampling data objects for analysis, the SCA component 110 can be made more scalable to handle larger amounts of data. Further, if through sampling, the SCA component 110 identifies a data object that raises a security/compliance concern, the SCA component 110 can stop scanning the data storage container 20 and perform one or more remedial actions, such as taking the data storage container 20 offline and/or alerting an administrator to move the data object 21.

In some examples, the SCA component 110 can maintain a list or index of data objects 21, data storage containers 20 or attributes thereof, that the SCA component 110 will not scan (e.g., “Do Not Scan” List). Such data objects 21 or data storage containers 20 can be known as having a propensity for false positives, meaning the analysis of the SCA component 110 can falsely identify data objects. The SCA component 110 can use a list or index to skip (or not scan) such data objects 21 or data storage containers 20, so as to avoid false positives. The identification of data objects 21 and data storage containers 20 that have a propensity for false positives can be based on historical data.

### Auxiliary Services

In examples, the SCA component 110 can also use auxiliary services 132 to process data objects 21. The auxiliary services 132 can include, for example, an object character recognition (OCR) engine which recognizes image data. The recognition can include identifying the presence of images, the object(s) detected in the images, and if the object depicts text, recognition of the depicted text as text data. The information obtained from the OCR engine can be used to analyze a data object for security/compliance concerns, such as the depiction of PII in image form in a data object 21 of the data storage container 20.

In additional examples, the SCA component 110 can use auxiliary services 132 that include a language translation engine and/or a country-specific library. The language translation engine can automatically detect when a data object 21 contains text data in a non-native language, and then translate that text to English. The country-specific library can identify data attributes, country-specific PII, specific types of data objects (e.g., driver's license), and formats in which certain types of data objects are provided. The SCA component 110 can use the auxiliary services 132 to translate data objects 21 into a native language (e.g., English) for analysis. Further, the SCA component 110 can use the auxiliary services 132 to identify non-native data object 21 and their respective formats for analysis.

### Remediation

The remediation component 120 can perform one or more actions to protect data objects 21 from unwanted exposure or risk. The remediation component 120 can perform one or more remediation actions in response to the SCA component 110 making a determination that a data object is not appropriate for a data storage container. As described with other examples, such determination can be made by the SCA component 110 when the determined security/compliance concern of a data object is greater than a contextual classification of the data storage container 20.

In examples, the remediation component 120 can perform any one of multiple possible remediation actions. The types of remediation actions that can be performed can vary based on factors such as level of the security/compliance concern of the data object that is the subject of remediation, the nature of the risk or harm presented by the data object that is to be remediated, and/or policies specified by the account holder or administrator.

In examples, the remediation actions can include generating an alert. The alert can identify the data storage container 20 and the particular data object where the security/compliance concern is raised. Additionally, the alert can indicate a remedial action that should take place (e.g., encrypt data object and/or move data object to a data storage container with a higher context classification). The alert can be generated for a programmatic entity (e.g., software service) to implement and resolve. Alternatively, the alert can be generated for an interface (e.g., provided by software on a computing device) used by an information technology (IT) administrator of the account holder for the data storage container 20.

As an addition or variation, the remedial actions can include generating a notification (e.g., message, content, etc.) that is transmitted to another device (e.g., administrator device) for action by a user. The notification can identify, for example, data storage container 20 and the particular data object 21 where the security/compliance concern is raised. Additionally, the notification can identify one or more recommended actions that a user can take, such as to encrypt the data object and/or move the data object to a different data storage container. In some examples, the identified storge container 20 can be taken offline until the user takes a remedial action such as moving the container, encrypting the container, or moving/encrypting a data object of the container.

In additional examples, the remediation component 120 can implement a remedial action where the data object with a raised security/compliance concern is moved out of its data storage container 20. The data object 21 can be placed in, for example, a protected network location that is isolated, apart from the data storage container 21. Such remedial action can be taken immediately, pending further evaluation or confirmation by an administrator.

The remediation actions that can be taken may vary based on settings or designations of the administrator or owner of the data storage container 20. For example, the remediation actions can be determined by profile information, such as designated or default actions specified by an account holder.

As an addition or variation, the remediation component 120 can automatically implement remedial actions where the data object is moved to a different data storage container 20 having a context classification that matches the rate security/compliance concern of the data object 21, further, the remediation component 120 can implement operations to secure or protect the data object in accordance with criteria associated with the higher context classification. For example, the remediation component 120 can encrypt the data objects 21 that is deemed to have the raised security/compliance concern.

For certain remedial/security concerns, an escalated protocol can be generated to trigger or otherwise facilitate immediate remedial action. In examples, if the passcode is determined to be active and provided with the data object 21, and the data object 21 is stored in a data storage container 20 having an intermediate or lesser context classification, then the remediation component 120 perform steps to implement the escalated protocol. This can include generating an incident report, isolating the data object 21 and or its data storage container 20, and/or generating an alert or notification to cause the account holder to disable the active passcode.

Additionally, remedial actions can be specific to particular types of security/compliance concerns. If the SCA component 110 detects vulnerable or compromised source code, the remediation component 120 can implement remedial actions that include extracting the data element (or portions thereof) from the data object 21. Alternatively, the remediation component 120 can perform actions to remove the data object 21 from the data storage container 20. As an addition or variation, the remediation component can associate a comment or alert with the data object 21 to warn against the use of the source code. As another addition or variation, the remediation component 120 can perform remedial actions that include raising an alert, communicating a notification to an account holder, isolating the source code away from its data storage container or making the data object inaccessible to other entities or users pending resolution of the detected vulnerability.

Accordingly, as described with examples, the remediation component 120 can implement any one of multiple types of remedial actions to mitigate against risk or harm from a data object that has a heightened level of security/compliance, relative to the context classification of its data storage container 20.

In additional examples, when a security/compliance concern is detected with a data container, the SCA component 110 can be configured to repeatedly check the data container again to check whether updates to the storage container cause additional security or compliance concerns. The identification of a security concern with a data container can be reflected in a risk profile associated with that data container 20.

Further, in instances when, for example, a particular type of security concern is identified (e.g., PII information), the remediation component 120 can implement operations to delete the delete the data object 21, move the data object 21, or delete the data storage container 20 of the data object 21. Further, the remediation component 120 can utilize exception rules to make exceptions for the handling of false positives. For example, the exception rule can provide that a data object 21 that appears to have a security or compliance concern may be un-remediated because the security/compliance concern is determined to be, or likely be a false positive.

### Methodology

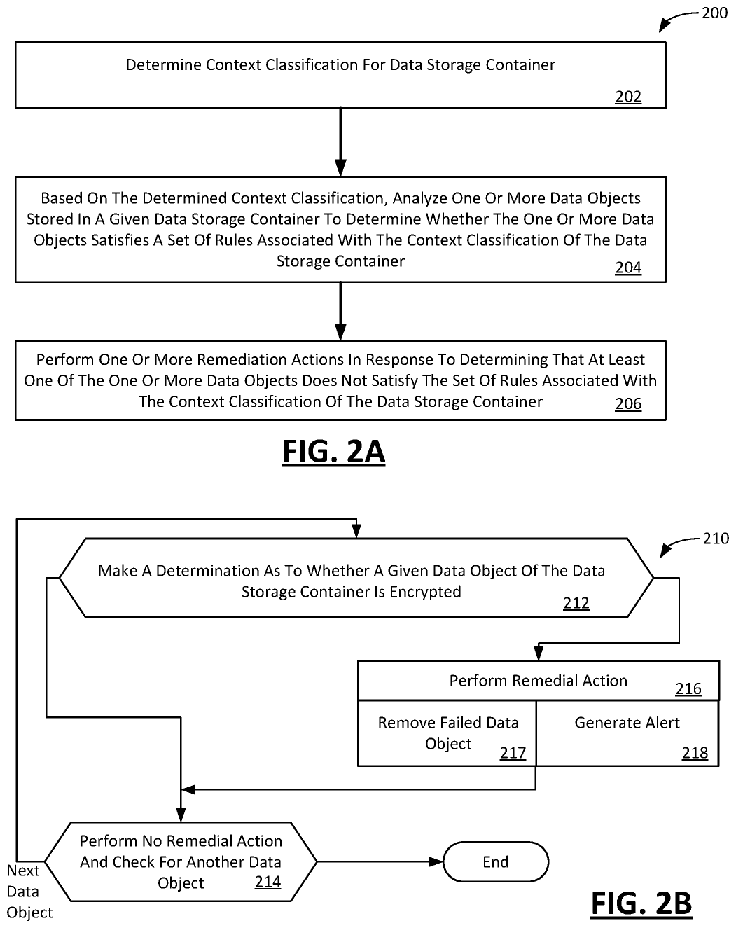

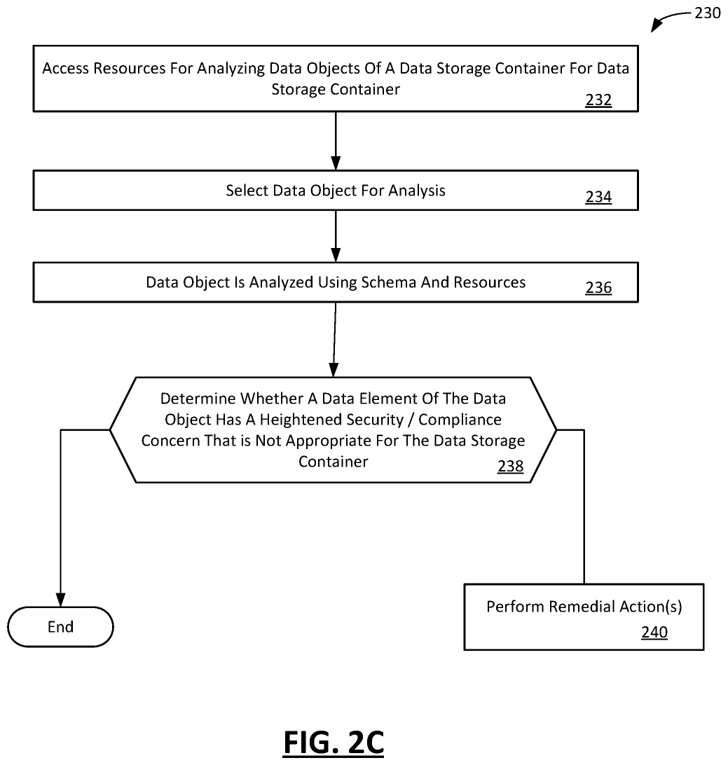

FIG. 2A illustrates a method 200 for implementing a security and compliance service, according to one or more embodiments. FIG. 2B illustrates a method 210 for performing a security and compliance service on a data storage container that includes a context classification for retaining highly sensitive data, according to one or more embodiments. FIG. 2C illustrates a method 230 for performing a security and compliance service on a data storage container that includes a context classification for intermediate and/or non-sensitive data, according to one or more embodiments. In describing examples of FIG. 2A through FIG. 2C, reference is made to elements of FIG. 1 for purpose of illustrating suitable components/functionality for implementing examples as described.

With reference to FIG. 2A through FIG. 2C, an example security and compliance service can be implemented for a network environment by a network computer system, such as network system 100. An example security and compliance service can be implemented in context of, for example, a data center or cloud computing environment where data for one or more enterprises are stored. An example security and compliance service can also be implemented by or for a network environment of an enterprise. Further, an example security and compliance service can be implemented continuously, periodically, at timed intervals, or responsively to pre-determined events.

In FIG. 2A, method 200 includes step 202, where the network system 100 determines a context classification 121 of a data storage container 20. In examples, the context classification 121 can correspond to i) highly sensitive (e.g., Level 1), where for example, all data objects of the data storage container 21 or to be fully encrypted, ii) an intermediate context classifications 121 (e.g., Level 2), where for example, highly sensitive data objects are to be excluded, and iii) a lower context classification 121 (e.g., Level 3), where public or other non-sensitive data is to be stored.

In examples, the determined context classification 121 can be pre-associated with the data storage container 20. In some variations, the context classification 121 can be determined from metadata, including profile information. For example, for a newly created data storage container, the context classification 121 can be initially determined from metadata that identifies an account/owner of the data storage container 20. A default rule may be associated with the account holder/owner where all newly created data storage containers 21 have a default context classification (e.g., Level 1).

In step 204, network system 100 analyzes, based on the determined context classification, one or more data objects 21 stored in a given data storage container 20 to determine whether each of the one or more data objects satisfies a set of rules associated with the context classification of the data storage container 20. The set of rules may define a criteria by which individual data objects 21 can be stored with the data storage container 20.

In step 206, the network system 100 performs one or more remediation actions in response to determining that at least one of the one or more data objects 21 does not satisfy the set of rules associated with the context classification 121 of the data storage container 20. If the determination is made that the data object being analyzed does not satisfy the criteria defined by the set of rules associated with the context classification, then a remediation action is performed with respect to the data object. The types of remediation action that are performed can vary, based on the context classification of the data storage container 20, attributes of the data object 21, and/or attributes relating to the data element that is the cause for the failed check. As described with examples, the remediation actions can include generating an alert or notification that identifies the data object 21 and the data storage container, removing the data object from the corresponding data storage container, or performing other remedial actions.

With reference to FIG. 2B, method 210 can be performed in response to a determination that the context classification 121 of the data storage container 20 is for highly sensitive data (e.g., Level 1 classification) (e.g., see step 202 of method 200). In variations, network system 100 can perform method 210 independent of performing of method 200. For example, method 210 can be performed by network system 100 operating in a mode where every data storage container 20 of the network environment is treated as being used to store highly sensitive data.

In step 212, the network system 100 makes a determination as to whether a given data object 21 of the data storage container 20 is encrypted. The determination of whether an individual data object 21 is encrypted can include determining an entropy value of the data object. For example, if the entropy value of the data object exceeds a threshold value, the data object 21 can be deemed as being encrypted

In response to the determination that a data object 21 of the data storage 20 container is encrypted, the network system 100 performs no further action on the data object. The network system 100 determine, in step 214, if another data object 21 in the data storage container 20 is to be checked for encryption. If another data object 21 exists to be checked, step 212 may be performed on the next data object 210. Else, method 210 ends, and no other data objects 21 are checked from the data storage container 20.

If, on the other hand, the determination of step 212 is that the data object 21 is not encrypted (e.g., fails check), in step 216, one or more remediation actions can be taken. The remediation actions can include, for example, one or more of (i) removing (or deleting) the failed data object 21 from the inspected data storage container 20 (step 217); and/or (ii) generating an alert to cause an administrator or owner of the data storage container 20 to take action (step 218). The alert can be generated as a notification or application alert for an administrator of the account owner. Still further, in other variations, the data object 21 can be prevented from being accessed while remaining in the data storage container 20. Alternatively, the data storage container can be taken off-line. In some variations, the data object 21 can be encrypted.

With reference to FIG. 2C, method 230 can be performed in response to a determination that the context classification 121 of the data storage container 20 permits non-encrypted retention of data storage objects 21. In some examples, the method 230 can be performed for data storage containers 20 in response to the data storage container having intermediate (e.g., Level 2) or lower level (e.g., Level 3) context classifications. In variations, network system 100 can perform method 210 independent of performing of method 200.

In step 232, the network system 100 accesses resources 111 for analyzing data objects 21 of a data storage container 20. The resources 111 can include a schema 115. The schema 115 can define data elements 21 of a sensitive type. The schema 115 can also define a context classification that is appropriate for different types of data elements. For example, the schema can identify criteria for specific types of data elements, including data elements that have the greatest level of security/compliance concern (e.g., Level 1), data elements that have an intermediate level of security/concern (e.g., Level 2), and data elements with the least amount of security/compliance concern (e.g., non-sensitive or public Level 3). For example, the types of data elements that have a highly sensitive security/compliance concern can include (i) credentials (e.g., passwords), (ii) personal identifiable information (e.g., driver license number, phone number, email addresses, etc.) and other information that is subject to legal requirements, and (iii) information that is subject to business rules (e.g., financial information of an enterprise). Data elements of a sensitive type can also include information that is potentially sensitive. For example, in some variations, a data element such as an access code, a password or a credential can be deemed a highly sensitive security/compliance concern if the data element is active or in use, such that the data element could potentially be used to access a protected resource.

The resources 111 can also include a rule set that specifies criteria for the inclusion or exclusion of data elements in a particular context classification. For example the rule set can include a rule that excludes a data element that has a highly-sensitive classification (e.g., Level 1) from being stored in a data storage container 20 that has a context classification that is lesser than the highly sensitive classification (e.g., Level 2 or Level 3 storage container). Likewise, the rule set can include a rule that excludes a Level 2 data object from being stored in a Level 3 data storage container. As an addition or alternative, the resources 111 can include a rule that requires data objects of an intermediate sensitivity application to be encrypted or password protected when stored in a data storage container 20. Accordingly, the rule set can implement an objective where the data objects 21 match the context classification of the respective data storage container 20. Accordingly, in examples, the rule set can provide that the context classification of a data object is not greater (of higher-sensitivity) than the context classification of the data storage container 20.

The schema 115 and/or resources 111 can be selected from a resource collection for a data storage container 20 that is to be analyzed. In examples, the schema 115 and/or other resources 111 can be selected based at least in part on metadata associated with a data storage container that contains data objects 21 to be analyzed. For example, the metadata can identify an account owner or enterprise with associated profile information, where the profile information includes or otherwise associates the account owner with a particular schema 115 and/or resources 111. As an addition or variation, the schema 115 and/or other resources can be selected based at least in part on the context classification of the data storage container 20 being analyzed.

In step 234, the network system 100 identifies a data object 21 from a data storage container 20 for analysis. The network system 100 can select the data object 21 based on, for example, attributes of the data object (e.g., creation date, modification date, etc.), such that, for example, new data objects or data objects that have not previously been analyzed are selected for analysis. Still further, in some variations, the data object 21 may be selected based on other attributes, such as the data type of the data object 21. In examples, the data object 21 can be selected for security/compliance review based on its data type. For example, a data object 21 that has a data type used for source code may be prioritized for selection, as such files may be associated with significant potential for harm to an enterprise or account holder. Examples of data types used for source code can include, for example, .JSON, .CPP, .CXX, .CC, .HPP, .TEXT. Alternatively, a data type which may hold passwords or credentials can be prioritized. In such implementations where data objects are selected for analysis from a corresponding data storage container 20, the prioritization or process for selecting data objects 21 may be specified at least in part by the resources 111 associated with the data storage container 20.

In step 236, the network system 100 uses the schema 115 and resources 111 to analyze the selected data object 21 for data elements that have a heightened security/compliance concern. In examples, the schema 115 can identify a structure, format and/or marker for specific types of data elements contained by data objects 21.

Based on the schema 115, in step 238, the network system 100 determines whether the data object includes data elements that have a security/compliance concern that is not appropriate for the context classification of the respective data storage container. If the network system 100 determines that the data object 21 contains no data elements with heightened security/compliance concerns, the network system 100 performs no action and the method may end in step 244.

In examples, the determination of whether a data element raises a heightened security/compliance concern can involve an initial determination of whether the data element has a potential heightened security/compliance concern. If the data element raises a potential heightened concern, additional operations are performed to determine whether the data object actually has a heightened concern. The network system 100 can analyze the data object 21 to identify data elements that are associated with potentially heightened security/compliance concerns. In some examples, the network system 100 can identify source code as a data element that has a potentially heightened security concern.

Data elements such as source code can be associated with embedded access codes or other passcodes, as a result of, for example, tendencies of developers who create the source code. The network system 100 can scan the source code for access codes, and if detected, the security /compliance concern for the data object is raised. As an addition or variation, the network system 100 can take additional programmatic actions to determine if the passcode is active, such as by applying to the passcode to a login page (e.g., such as hosted on an external site) for the passcode. If the passcode is active, then the network system 100 can raise the security/compliance concern for the data object.

As another example, source code can be identified as raising a potential heightened security/compliance concern, represented by malware or vulnerabilities which may be present in the source code and compromise a network resource if used. The network system 100 can compare the source code with a library of malware code and other vulnerabilities in order to determine whether the source code raises an issue.

If the network system 100 determines that the data object 21 includes one or more data elements that have a greater security/compliance concern that what is permitted based on the context classification of the respective data storage container, the network system 100 performs, in step 240, one or more remedial actions. As described with various examples, the remedial actions can include generating an alert or notification, removing the data object from the data storage container 20, making the data storage container 20 inaccessible or subject to more security, implementing an escalated protocol to implement additional measures relating to the data object or related resource (e.g., online code repository), and/or other action.

The remedial action can be determined in part by the level of the security/compliance concern raised by the data element. As an addition or variation, the remedial action can be based on the type of data element. For example, as described below, an active access code or other type of passcode can raise an escalated protocol where the data storage container 20 is taken offline and notification or other steps or taken to have an administrator change the active credential.

The remedial action can also be specific to situations such as the data object including source code that includes malware or is otherwise vulnerable. In such cases, the network system 100 can perform additional remedial actions, such as extracting the data element or portions thereof (e.g., lines of code) from the data object 21, removing the data object from the data storage container 20, and/or associating a comment or alert with the data object 21 to warn against the use of the source code.

### Hardware Diagram

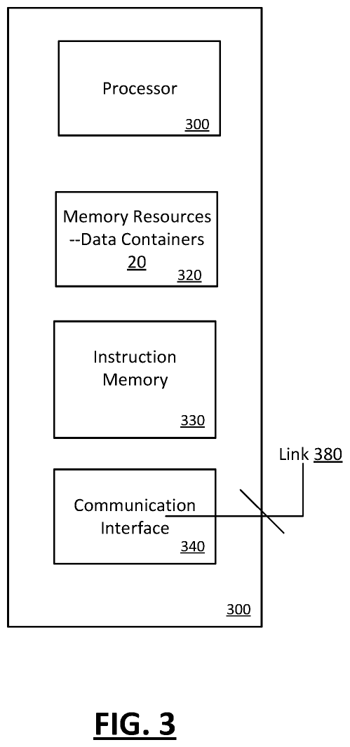

FIG. 3 is a block diagram that illustrates a network computer system upon which one or more embodiments described herein can be implemented. A network system such as described an example of FIG. 1 can be implemented using a computing system 300 of FIG. 3. Further, example methods such as described with FIG. 2A through FIG. 2C can be implemented using the network computer system 300.

In one implementation, the network computer system 300 includes one or more processors 310, memory resources 320, instruction memory 330 and a communication interface 350. The network computer system 300 includes at least one processor 310 for processing information. The memory resources 220 may include a random access memory (RAM), dynamic storage elements, cache and related firmware and logic for enabling the network computer system to provide a network environment for maintaining data storage containers 20 and data objects, as described with one or more embodiments. The instruction memory 330 can store instructions for implementing a security and compliance service, such as described with examples of FIG. 1. The instruction memory 330 can store information and instructions to be executed by the processor(s) 310. The instruction memory 330 may be used for storing temporary variables or other intermediate information during execution of instructions to be executed by the processor(s) 310.

The communication interface 350 can enable the network computer system 300 to communicate with one or more networks 380 (e.g., cellular network) through use of the network link (wireless or wireline). Using the network link, the network computer system 300 can communicate with one or more other computing devices and/or one or more other servers or data centers. In some variations, the network computer system 300 can receive service requests from requester devices via the network link 380. Additionally, the network computer system 300 can receive information from provider devices, from which forecasts of provisioning levels, location bias and other aspects described herein may be determined.

Examples described herein are related to the use of the network computer system 300 for implementing the techniques described herein. According to one embodiment, those techniques are performed by the network computer system 300 in response to the processor 310 executing one or more sequences of one or more instructions contained in the instruction resource 330. Such instructions may be read into a main memory from another machine-readable medium, such as a storage device. Execution of the sequences of instructions contained in the instruction resource 430 causes the processor 310 to perform the process steps described herein. In alternative implementations, hard-wired circuitry may be used in place of or in combination with software instructions to implement examples described herein. Thus, the examples described are not limited to any specific combination of hardware circuitry and software.

### Conclusion

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A non-transitory computer-readable medium that stores instructions, which when executed by one or more processors, cause the one or more processors to perform operations that include:
determining a context classification of a data storage container, the data storage container being provided with a memory resource of a network computing environment;
based on the context classification, analyzing one or more data objects stored in the data storage container to determine whether each of the one or more data objects satisfies a set of rules associated with the context classification of the data storage container; and
in response to determining that at least one of the one or more data objects does not satisfy the set of rules associated with the context classification, performing one or more remediation actions.

2. The non-transitory computer-readable medium of claim 1, wherein the context classification is tiered to reflect a level of a security or compliance concern of data objects that are stored in the data storage container.

3. The non-transitory computer-readable medium of claim 2, wherein the context classification indicates that the data storage container is to store data objects with a highest security or compliance concern, and wherein analyzing the one or more data objects includes determining whether each of the one or more data objects is encrypted.

4. The non-transitory computer-readable medium of claim 3, wherein determining whether each of the one or more data objects is encrypted includes determining an entropy of each of the one or more data objects.

5. The non-transitory computer-readable medium of claim 1, wherein the set of rules associated with the context classification provides that the data storage container is not to store data objects with a highest security or compliance concern, and wherein analyzing the one or more data objects of the data storage container includes scanning a content of each of the one or more data objects based on a schema.

6. The non-transitory computer-readable medium of claim 5, wherein analyzing the one or more data objects includes selecting, from a plurality of data objects that are stored with the data storage container, a set of one or more data objects to analyze, wherein the set of one or more data objects are selected based at least in part on a set of attributes for each of the one or more data objects and one or more rules of the schema.

7. The non-transitory computer-readable medium of claim 5, wherein the schema identifies one or more of a structure, format or marker for one or more types of data elements.

8. The non-transitory computer-readable medium of claim 1, wherein the one or more remediation actions are based at least in part on the context classification of the data storage container.

9. The non-transitory computer-readable medium of claim 1, wherein the one or more remediation actions include generating an alert for at least one of the data storage container or each of the one or more data objects that fails to satisfy the set of rules.

10. The non-transitory computer-readable medium of claim 9, wherein the one or more remediation actions include isolating at least one of the one or more data objects from the data storage container.

11. The non-transitory computer-readable medium of claim 1, wherein analyzing the one or more data objects of the data storage container includes scanning a content of each of the one or more data objects for a type of secret data.

12. The non-transitory computer-readable medium of claim 11, wherein the type of secret data includes passcodes.

13. The non-transitory computer-readable medium of claim 11, wherein scanning the content of the one or more data objects includes scanning source code content of a file or document for an access key to a source code repository.

14. The non-transitory computer-readable medium of claim 13, wherein the operations further include determining whether the access key is active.

15. The non-transitory computer-readable medium of claim 14, wherein performing the one or more remedial actions includes, in response to determining the access key is active, implementing a set of incident actions to protect the source code repository.

16. The non-transitory computer-readable medium of claim 1, wherein analyzing one or more objects of the data storage container include analyzing a source code provided on a file or document to determine whether the source code is vulnerable.

17. A computer system comprising:
one or more processors;
a memory to store instructions;
wherein the one or more processors store instructions, which when executed by the one or more processors, cause the one or more processors to perform operations that include:
determining a context classification of a data storage container, the data storage container being provided with a memory resource of a network computing environment;
based on the context classification, analyzing one or more data objects stored in the data storage container to determine whether each of the one or more data objects satisfies a set of rules associated with the context classification of the data storage container; and
in response to determining that at least one of the one or more data objects does not satisfy the set of rules associated with the context classification, performing one or more remediation actions.

18. The computer system of claim 17, wherein the context classification is tiered to reflect a level of a security or compliance concern of data objects that are stored in the data storage container.

19. The computer system if claim 18, wherein the context classification indicates that the data storage container is to store data objects with a highest security or compliance concern, and wherein analyzing the one or more data objects includes determining whether each of the one or more data objects is encrypted.

20. A computer implemented method comprising:
determining a context classification of a data storage container, the data storage container being provided with a memory resource of a network computing environment;
based on the context classification, analyzing one or more data objects stored in the data storage container to determine whether each of the one or more data objects satisfies a set of rules associated with the context classification of the data storage container; and
in response to determining that at least one of the one or more data objects does not satisfy the set of rules associated with the context classification, performing one or more remediation actions.
